(19) United States
(12) Patent Application Publication
(10) Pub. No.: US 2015/0355941 A1
(43) Pub. Date: Dec. 10, 2015

(54) INFORMATION PROCESSING DEVICE AND METHOD FOR CONTROLLING INFORMATION PROCESSING DEVICE

(71) Applicant: FUJITSU LIMITED, Kawasaki-shi (JP)

(72) Inventor: Jumpei KUBOTA, Yokohama (JP)

(73) Assignee: Fujitsu Limited, Kawasaki-shi (JP)

(21) Appl. No.: 14/683,711

(22) Filed: Apr. 10, 2015

(30) Foreign Application Priority Data
Jun. 6, 2014 (JP) 2014-117406

(51) Int. Cl. G06F 9/48; G06F 1/20; G06F 9/50

(52) U.S. Cl. CPC G06F 9/4893; G06F 9/5094; G06F 1/20

(57) ABSTRACT

An information processing device includes arithmetic processing devices, a cooling device, and a job assignment device. Each of the arithmetic processing devices is configured to perform a job. The cooling device is connected to the arithmetic processing devices. The cooling device includes a circulation unit, a cooling unit, and an adjustment unit. The circulation unit is configured to circulate refrigerant through a supply route. The refrigerant absorbs heat generated by the arithmetic processing devices. The cooling unit is configured to cool the refrigerant circulated by the circulation unit. The adjustment unit is configured to adjust, in response to a temperature of the refrigerant, a cooling capacity of the cooling unit to cool the refrigerant. The job assignment device includes a processor configured to control, on the basis of cooling capacity information indicating the cooling capacity, job charging to the arithmetic processing devices.

### CROSS-REFERENCE TO RELATED APPLICATION

This application is based upon and claims the benefit of priority of the prior Japanese Patent Application No. 2014-117406, filed on Jun. 6, 2014, the entire contents of which are incorporated herein by reference.

### FIELD

The embodiments discussed herein are related to an information processing device and a method for controlling the information processing device.

### BACKGROUND

Recently, with an increase in the processing capacity of an information processing device that includes a processor, an amount of heat generated by the information processing device tends to increase. In order to suppress an increase in the temperature due to heat that is generated by the information processing device, the information processing device is cooled, for example, by an air-cooling fan or a cooling device such as a circulation device that circulates liquid coolant through a supply route that is in contact with the information processing device.

For example, a decrease in the cooling performance of the cooling device may be detected by outputting a warning in a case where a difference between an expected value of the temperature when a load is applied to the processor and an actual temperature of the processor, which is measured by a temperature sensor, exceeds a threshold value. When a temperature sensor is provided for each of a plurality of information processing devices, the energy that is used to cool the information processing device may be saved by transferring a part of software from an information processing device whose temperature is high as compared with those of the other information processing devices to an information processing device whose temperature is low as compared with those of the other information processing devices. Similarly, when a temperature sensor is provided for each of a plurality of information processing devices, the energy that is used to cool the information processing device may be saved by charging a job to an information processing device whose temperature is low as compared with those of the other information processing devices.

Related techniques are disclosed in, for example, Japanese Laid-open Patent Publication No. 2009-070140, Japanese Laid-open Patent Publication No. 2012-038348, and Japanese Laid-open Patent Publication No. 2004-126968.

In a case where there is only a small margin for the cooling capacity of the cooling device that cools the information processing device, even when charge of a job to the information processing device is stopped based on the temperature of the information processing device, which is measured by the temperature sensor, the temperature of the information processing device may further increase. When the temperature of the information processing device goes beyond the normal range, for example, the information processing device may be stopped, and the normal information processing may not be performed.

### SUMMARY

According to an aspect of the present invention, provided is an information processing device including first arithmetic processing devices, a first cooling device, and a job assignment device. Each of the first arithmetic processing devices is configured to perform a job. The first cooling device is connected to the first arithmetic processing devices. The first cooling device includes a first circulation unit, a first cooling unit, and a first adjustment unit. The first circulation unit is configured to circulate first refrigerant through a first supply route. The first refrigerant absorbs heat generated by the first arithmetic processing devices. The first cooling unit is configured to cool the first refrigerant circulated by the first circulation unit. The first adjustment unit is configured to adjust, in response to a first temperature of the first refrigerant, a first cooling capacity of the first cooling unit to cool the first refrigerant. The job assignment device includes a processor configured to control, on the basis of cooling capacity information indicating the first cooling capacity, job charging to the first arithmetic processing devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing device according to a first embodiment;

FIG. 2 is a diagram illustrating an example in which a job assignment device according to the first embodiment controls job charging;

FIG. 3 is a diagram illustrating an example of processing in which the job assignment device according to the first embodiment controls job charging;

FIG. 4 is a diagram illustrating an example of processing in which the job assignment device according to the first embodiment controls job charging;

FIG. 5 is a diagram illustrating an example in which another job assignment device controls job charging;

FIG. 6 is a diagram illustrating an example in which a job assignment device according to a second embodiment controls job charging;

FIG. 7 is a diagram illustrating an example of processing in which the job assignment device according to the second embodiment controls job charging;

FIG. 8 is a diagram illustrating an information processing device according to a third embodiment;

FIG. 9 is a diagram illustrating an example in which a job assignment device according to the third embodiment controls job charging;

FIG. 10 is a diagram illustrating an example of processing in which the job assignment device according to the third embodiment controls job charging;

FIG. 11 is a diagram illustrating an information processing device according to a fourth embodiment;

FIG. 12 is a diagram illustrating an example of processing in which a job assignment device according to the fourth embodiment controls job charging;

FIG. 13 is a diagram illustrating an information processing device according to a fifth embodiment;

FIG. 14 is a diagram illustrating an example of processing in which a job assignment device according to the fifth embodiment controls job charging; and

FIG. 15 is a diagram illustrating an example of processing in which a job assignment device according to a sixth embodiment controls job charging.

### DESCRIPTION OF EMBODIMENTS

Embodiments will be described below with reference to the drawings.

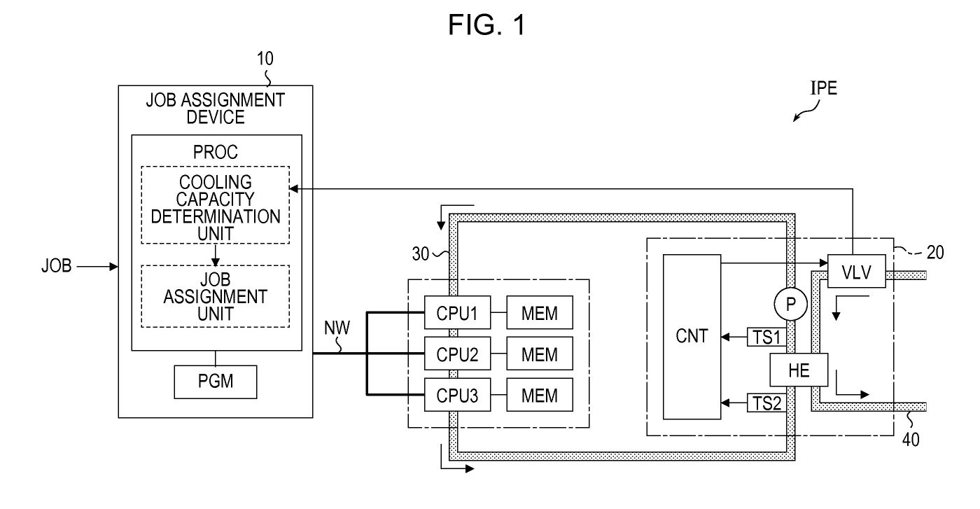

FIG. 1 is a diagram illustrating an information processing device according to a first embodiment. An information processing device IPE illustrated in FIG. 1 includes a job assignment device 10, a plurality of central processing units (CPUs) CPU1, CPU2, and CPU3, and memories MEM that are respectively connected to the CPU1, CPU2, and CPU3. The CPU is an example of an arithmetic processing device that performs a job. The information processing device IPE also includes a circulation device 20 for liquid coolant, a supply route 30 that is connected between the circulation device 20 and the CPU1, CPU2, and CPU3 to circulate the liquid coolant, and a supply route 40 that is connected to the circulation device 20 to supply refrigerant. The supply route 30 is in contact with each of the CPU1, CPU2, and CPU3. The shaded portion of the supply route 30 indicates the liquid coolant that flows through the supply route 30, and the shaded portion of the supply route 40 indicates the refrigerant that flows through the supply route 40.

Each memory MEM stores a program that is executed by the CPU, data that is used for a job that is performed by the CPU, and the like. The number of CPUs that are included in the information processing device IPE is not limited to three, and may be one, two, four, or more. The CPU1, CPU2, and CPU3 may be products that have the same specification (type, clock frequency, power-supply voltage, or the like), or may be products that respectively have different specifications.

The circulation device 20 includes a controller CNT, temperature sensors TS1 and TS2, a pump P that sends the liquid coolant to the supply route 30, a valve VLV through which the refrigerant is supplied to the supply route 40, and a heat exchanger HE that performs heat exchange between the liquid coolant and the refrigerant. The liquid coolant is an example of refrigerant that absorbs heat generated by the CPUs. Through the supply route 30, gas such as coolant gas may flow instead of the liquid coolant. The liquid coolant that is output from the circulation device 20 by the driving force of the pump P flows through the supply route 30 in a direction indicated by an arrow in FIG. 1, absorbs heat generated by the CPU1, CPU2, and CPU3, and is returned to the circulation device 20. After the liquid coolant that has been returned to the circulation device 20, heat exchange is performed between the refrigerant and the liquid coolant in the heat exchanger HE, and the liquid coolant is again output from the circulation device 20 by the driving force of the pump P. The driving force (for example, the rotational speed) of the pump P is fixed, and the flow rate of the liquid coolant that is supplied to the supply route 30 is fixed, for example. The pump P is an example of a circulation unit that circulates the liquid coolant through the supply route 30, and the heat exchanger HE is an example of a cooling unit that cools the liquid coolant that is circulated by the pump P. The circulation device 20 is an example of a cooling device that includes the pump P, the heat exchanger HE, the valve VLV, and the controller CNT.

The temperature sensor TS1 measures the temperature of the liquid coolant after the heat exchange is performed thereon by the heat exchanger HE. The temperature sensor TS2 measures the temperature of the liquid coolant that has been returned to the circulation device 20 and before the heat exchange is performed thereon by the heat exchanger HE. Therefore, when any one of the CPU1, CPU2, and CPU3 performs a job, the temperature of the liquid coolant, which is measured by the temperature sensor TS2, is higher than the temperature of the liquid coolant, which is measured by the temperature sensor TS1.

For example, The controller CNT includes a processor that executes a program for controlling the circulation device 20 to adjust the opening degree of the valve VLV, that is, the flow rate of the refrigerant that flows through the supply route 40 is adjusted, based on pieces of information that indicate the temperatures of the liquid coolant and are received from the temperature sensors TS1 and TS2. Opening degree information (here, the state in which the valve VLV is closed corresponds to 0%, and the maximum opening degree corresponds to 100%) that indicates the opening degree of the valve VLV is output to the job assignment device 10. The opening degree information is an example of cooling capacity information that indicates the cooling capacity of the refrigerant, which is adjusted by the controller CNT.

When the opening degree of the valve VLV is large, the cooling capacity of the refrigerant to cool the liquid coolant is high as compared with a case in which the opening degree of the valve VLV is small. That is, the opening degree of the valve VLV indicates the cooling capacity of the refrigerant to cool the liquid coolant. As the opening degree of the valve VLV becomes larger, the margin of the cooling capacity of the refrigerant to cool the liquid coolant becomes smaller. For example, the margin of the cooling capacity to cool the liquid coolant when the opening degree of the valve VLV is 100% is smaller than the margin of the cooling capacity to cool the liquid coolant when the opening degree of the valve VLV is 80%.

For example, the controller CNT adjusts the opening degree of the valve VLV so that the temperature that is indicated by the temperature sensor TS1 is maintained so as to be fixed, based on a difference between the temperature that is indicated by the temperature sensor TS2 and the temperature that is indicated by the temperature sensor TS1. While the CPUs are performing a job, the temperature that is indicated by the temperature sensor TS2 is higher than the temperature that is indicated by the temperature sensor TS1 due to heat that is generated by the CPUs. The controller CNT adjusts the opening degree of the valve VLV so that the temperature that is indicated by the temperature sensor TS1 is maintained at 25 degrees Celsius (25° C.), for example, but not limited to. The controller CNT and the valve VLV are examples of an adjustment unit that adjusts the cooling capacity of the heat exchanger HE that cools liquid coolant by heat exchange.

For example, when the number of jobs that are charged to the CPU1, CPU2, and CPU3 is increased, and the difference between the temperatures that are indicated by the temperature sensors TS1 and TS2 becomes larger, the controller CNT causes the flow rate of the refrigerant that flows through the supply route 40 to be increased by increasing the opening degree of the valve VLV. As a result, an amount of heat exchange between the refrigerant and the liquid coolant is increased, and the temperature of the liquid coolant is maintained so as to be fixed.

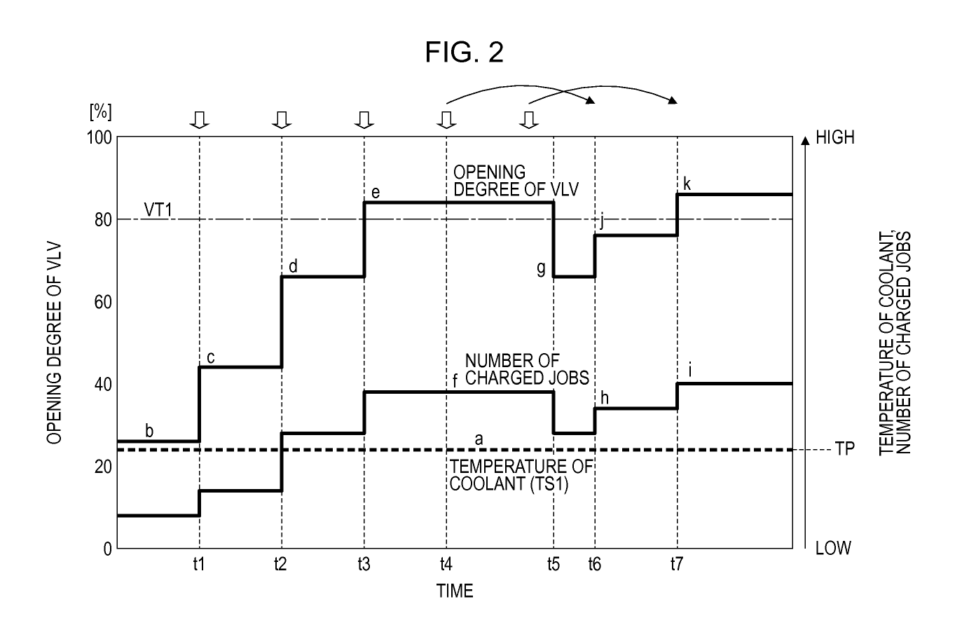

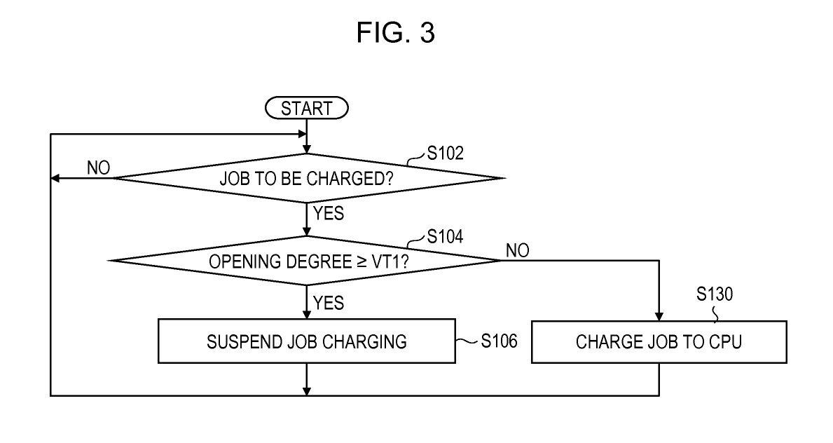

The job assignment device 10 is connected to the CPU1, CPU2, and CPU3 through a network NW. The job assignment device 10 includes a processor PROC that executes a program PGM that is stored in a memory, and assigns a job to a CPU that is to perform the job, by an operation of the processor PROC. In addition, the job assignment device 10 charges the assigned job to one of the CPU1, CPU2, and CPU3 through the network NW. At that time, the job assignment device 10 determines the cooling capacity (or the margin of the cooling capacity) of the liquid coolant to cool the CPU1, CPU2, and CPU3 on the basis of the opening degree information that indicates the opening degree of the valve VLV, and controls charge (hereinafter, referred to as job charging) of a job to the CPU1, CPU2, and CPU3 on the basis of the determined cooling capacity. That is, the processor PROC that executes the program PGM functions as a cooling capacity determination unit that determines the cooling capacity of the liquid coolant and a job assignment unit that assigns jobs to the CPU1, CPU2, and CPU3. The control of job charging to the CPUs, which is performed by the job assignment device 10, will be described with reference to FIGS. 2 and 3. For example, the job is supplied from a host device such as a user device that uses the information processing device IPE. The program PGM is an example of a program which is executed by the job assignment device 10 to control the information processing device IPE that assigns jobs to be performed by the CPU1, CPU2, and CPU3 to the CPU1, CPU2, and CPU3.

FIG. 2 illustrates an example in which the job assignment device 10 according to the first embodiment controls job charging. For example, when the opening degree of the valve VLV is less than a threshold value VT1, the job assignment device 10 determines that jobs may be charged to the CPU1, CPU2, and CPU3 because there is a sufficient margin for the cooling capacity of the liquid coolant to cool the CPU1, CPU2, and CPU3. On the other hand, when the opening degree of the valve VLV is the threshold value VT1 or more, the job assignment device 10 suppresses job charging to the CPU1, CPU2, and CPU3 because there is only a small margin for the cooling capacity of the liquid coolant to cool the CPU1, CPU2, and CPU3. In the example illustrated in FIG. 2, the threshold value VT1 is 80%. As illustrated in FIG. 1, the controller CNT of the circulation device 20 maintains the temperature of the liquid coolant, which is indicated by the temperature sensor TS1, at a fixed temperature TP by adjusting the opening degree of the valve VLV (“a” in FIG. 2).

Before a time t1, a certain number of jobs are charged to the CPUs (at least one of the CPU1, CPU2, and CPU3), and the opening degree of the valve VLV is set at a value to maintain the temperature of the liquid coolant, which is indicated by the temperature sensor TS1, at the fixed temperature (“b” in FIG. 2).

At each of the times t1, t2, and t3, in response to an instruction of job charging received from the host device, the job assignment device 10 assigns a job to a CPU and charges the assigned job to the CPU because the opening degree of the valve VLV is less than the threshold value VT1. In FIG. 2, the instruction of job charging received from the host device is indicated by an outline arrow. Due to the job charging, the load on the CPU is increased, and an amount of heat that is generated by the CPU is increased, and the temperature of the liquid coolant, which is measured by the temperature sensor TS2, becomes higher. That is, a difference between the temperature that is indicated by the temperature sensor TS2 and the temperature that is indicated by the temperature sensor TS1 becomes larger. The controller CNT sequentially increases the opening degree of the valve VLV so that the temperature that is indicated by the temperature sensor TS1 is maintained so as to be fixed (“c”, “d”, and “e” in FIG. 2). For example, due to the job charging at the time t3, the opening degree of the valve VLV becomes the threshold value VT1 or more.

At the time t4, the job assignment device 10 receives an instruction of job charging from the host device but suspends the job charging and stacks the job to be charged because the opening degree of the valve VLV is the threshold value VT1 or more (“f” in FIG. 2). That is, the number of jobs that are charged to the CPUs is not increased. While the opening degree of the valve VLV is the threshold value VT1 or more, new jobs are not charged to the CPUs, so that the temperature of the liquid coolant, which is indicated by the temperature sensor TS2, is not increased. Therefore, the opening degree of the valve VLV may be maintained so as to be fixed, and the temperature of the liquid coolant may be maintained so as to be fixed.

At the time t5, at least one of the jobs that are being performed by the CPUs is completed, and the amount of heat that is generated by the CPUs is reduced as compared with that at the time t4, and the temperature of the liquid coolant, which is measured by the temperature sensor TS2, is reduced. That is, the difference between the temperature that is indicated by the temperature sensor TS2 and the temperature that is indicated by the temperature sensor TS1 becomes smaller.

When the opening degree of the valve VLV is maintained at the threshold value VT1 or more despite the reduction in the temperature of the liquid coolant, which is measured by the temperature sensor TS2, the temperature that is indicated by the temperature sensor TS1 (temperature of the liquid coolant that cools the CPU) may become lower than the temperature TP. When the temperature that is indicated by the temperature sensor TS1 becomes lower than the temperature of a space in which the information processing device IPE is installed, the information processing device IPE may become an over-cooling state in which dew condensation occurs on the supply route 30 or the CPUs. Therefore, the controller CNT reduces the opening degree of the valve VLV so that the temperature that is indicated by the temperature sensor TS1 is maintained so as to be fixed. As a result, the opening degree of the valve VLV becomes smaller than the threshold value VT1 (“g” in FIG. 2).

At the times t6 and t7, the job assignment device 10 sequentially charges the stacked jobs to the CPUs (“h” and “i” in FIG. 2) because the opening degree of the valve VLV is smaller than the threshold value VT1. That is, the job charging to the CPUs is resumed. Similar to “c” and “d” in FIG. 2, due to the job charging, the amount of heat that is generated by the CPUs is increased, and the temperature of the liquid coolant, which is measured by the temperature sensor TS2, is increased, therefore the controller CNT sequentially increases the opening degree of the valve VLV (“j” and “k” in FIG. 2).

FIG. 3 illustrates an example of processing in which the job assignment device 10 according to the first embodiment controls job charging. The job assignment device 10 performs the processing of the flow illustrated in FIG. 3 by executing the program PGM. That is, FIG. 3 illustrates an example of a method for controlling the information processing device IPE.

First, in S102, the job assignment device 10 determines whether or not there is a job that is to be charged to the CPUs. When there is a job that is to be charged to the CPUs, the processing proceeds to S104. When there is no job that is to be charged to the CPUs, the processing of S102 is repeated.

In S104, the job assignment device 10 determines whether or not the opening degree of the valve VLV is the threshold value VT1 or more. When the opening degree of the valve VLV is the threshold value VT1 or more, the processing proceeds to S106. When the opening degree of the valve VLV is less than the threshold value VT1, the processing proceeds to S130.

In S106, the job assignment device 10 suspends job charging, and the processing returns to S102. In S130, the job assignment device 10 assigns a job to a CPU, and charges the assigned job to the CPU. With the flow illustrated in FIG. 3, the control illustrated in FIG. 2 is achieved.

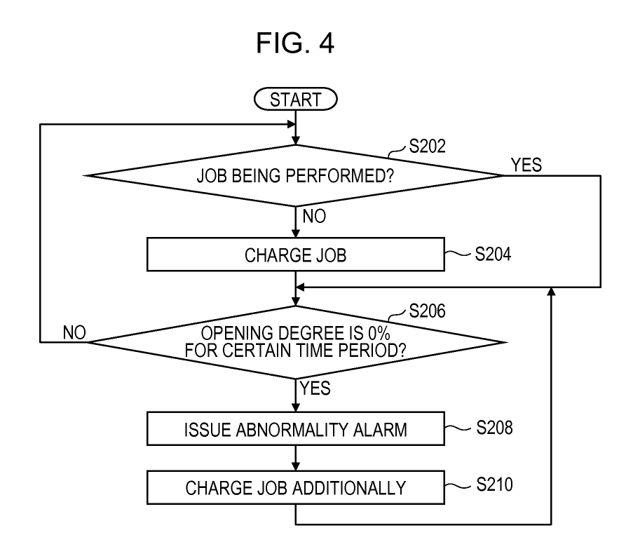

FIG. 4 illustrates another example of processing that is performed by the job assignment device 10 according to the first embodiment. The job assignment device 10 performs the processing of the flow illustrated in FIG. 4 by executing the program PGM. That is, FIG. 4 illustrates an example of a method for controlling the information processing device IPE. For example, the job assignment device 10 performs the processing of the flow illustrated in FIG. 4 in parallel with the processing of the flow illustrated in FIG. 3.

First, in S202, the job assignment device 10 determines whether or not there is a job that is being performed by the CPUs. When there is a job that is being performed by the CPUs, the processing proceeds to S206. When there is no job that is being performed by the CPUs, the processing proceeds to S204.

In S204, the job assignment device 10 causes the CPUs (at least one of the CPU1, CPU2, and CPU3) to generate heat, for example, by charging a dummy job to the CPUs. After S204, the processing proceeds to S206.

In S206, the job assignment device 10 determines whether or not the opening degree of the valve VLV is 0% for a certain time period. When the opening degree of the valve VLV is 0% for the certain time period, the processing proceeds to S208. When the opening degree of the valve VLV exceeds 0% within the certain time period, the processing returns to S202.

In S206, since at least one of the CPUs generates heat by performing a job, the temperature of the liquid coolant, which is indicated by the temperature sensor TS2, becomes higher than the temperature of the liquid coolant, which is indicated by the temperature sensor TS1. Therefore, the controller CNT is expected to set the opening degree of the valve VLV at a value that exceeds 0% when the circulation device 20 operates normally. That is, in S206, when the opening degree of the valve VLV is 0% for a certain time period, the circulation device 20 may have an abnormality such as a failure of the valve VLV.

In S208, based on the determination result in S206, the job assignment device 10 issues an abnormality alarm that indicates that an abnormality occurs in the circulation device 20, for example, to the host device or a management device that manages the information processing device IPE. That is, when the opening degree of the valve VLV is not changed after job charging to the CPUs, the job assignment device 10 detects an abnormality in the circulation device 20.

For example, when opening degree information that is output to the job assignment device 10 indicates 0% due to the failure of the valve VLV despite the situation that the opening degree of the valve VLV is fixed at 50%, the temperature of the liquid coolant, which is indicated by the temperature sensor TS1, may become lower than the temperature TP illustrated in FIG. 2. As a result, when dew condensation occurs due to over-cooling of the supply route 30 or over-cooling of the CPUs, the CPUs or the information processing device IPE may be failed. In order to suppress dew condensation due to the over-cooling, the job assignment device 10 performs S210.

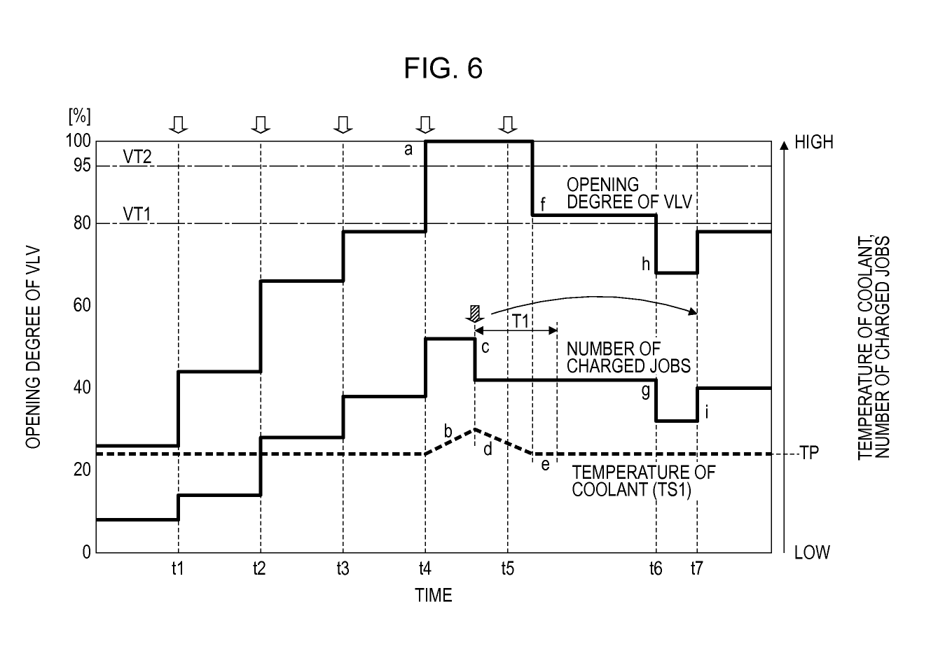

In S210, by charging an additional dummy job to the CPUs (at least one of the CPU1, CPU2, and CPU3), the job assignment device 10 further causes the CPUs to generate heat to increase the temperature of the liquid coolant, and then the processing proceeds to S206. After the additional job charging is repeated a certain number of times in S210, the processing loop of S210, S206, and S208 may be stopped. The job assignment device 10 may omit to perform the processing of the flow illustrated in FIG. 4, and perform only the processing of the flow illustrated in FIG. 3. The processing of the flow illustrated in FIG. 4 may be performed by a job assignment device according to an embodiment illustrated in FIG. 6 or subsequent drawings.

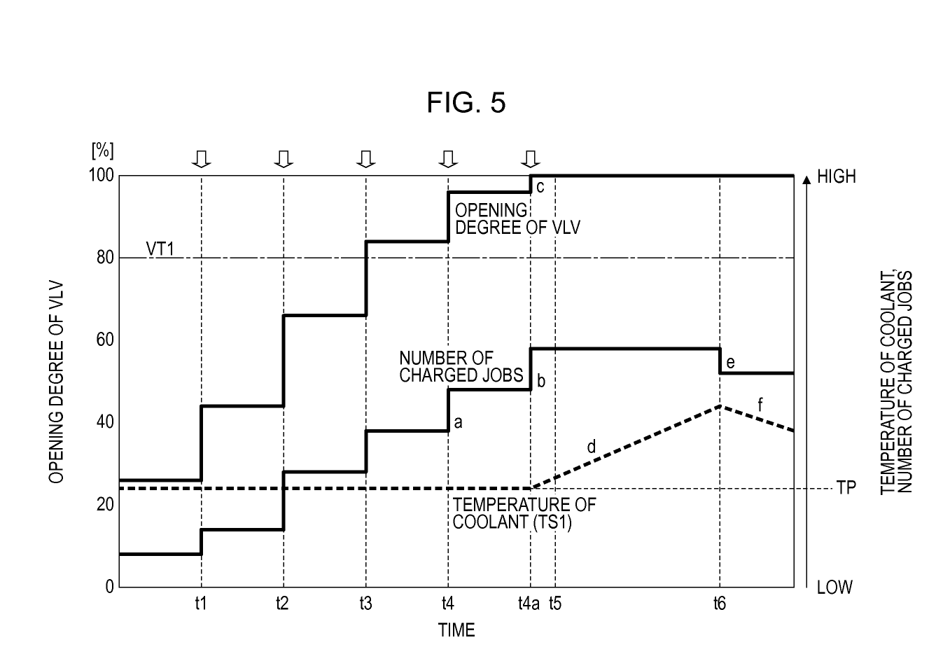

FIG. 5 illustrates an example in which another job assignment device controls job charging. Detailed description of an operation that is similar to that in FIG. 2 is omitted herein. The operations until the time t3 are similar to that in FIG. 2. The job assignment device that performs the control illustrated in FIG. 5 assigns a job to the CPUs without receiving opening degree information from the valve VLV illustrated in FIG. 1.

At the times t4 and t4a, in response to an instruction of job charging received from the host device, the job assignment device 10 assigns a job to a CPU and charges the assigned job to the CPU (“a” and “b” in FIG. 5) regardless of the opening degree of the valve VLV. Due to the job charging, the amount of heat that is generated by the CPUs is increased, and the temperature of the liquid coolant, which is measured by the temperature sensor TS2, becomes higher. The controller CNT increases the opening degree of the valve VLV so that the temperature that is indicated by the temperature sensor TS1 is maintained so as to be fixed.

However, at the time t4a, the opening degree of the valve VLV becomes 100%, and the cooling capacity of the refrigerant to cool the liquid coolant reaches the maximum, and there is no margin for the cooling capacity (“c” in FIG. 5). Therefore, it becomes difficult for the refrigerant to reduce the temperature of the liquid coolant, which is increased due to generation of heat by the CPUs, and the temperature of the liquid coolant, which is indicated by the temperature sensor TS1, is gradually increased (“d” in FIG. 5). The increase in the temperature of the liquid coolant, which is indicated by the temperature sensor TS1, is continued, for example, until any one of the jobs that are being performed by the CPUs is completed (“e” in FIG. 5). At the time t6, when any one of the jobs that are being performed by the CPUs is completed, the temperature of the liquid coolant, which is indicated by the temperature sensor TS1, is gradually reduced (“f” in FIG. 5). Though not illustrated in FIG. 5, the opening degree of the valve VLV becomes less than 100% at a time at which the temperature of the liquid coolant, which is indicated by the temperature sensor TS1, is returned to the temperature TP.

For example, after the time t5, when job charging to the CPUs is instructed continuously, the temperature of the liquid coolant, which is indicated by the temperature sensor TS1, is kept to be increased. As a result, when the temperature of the CPUs is increased up to the maximum temperature that is defined in the electrical specification, the CPUs may operate abnormally, or may be failed. That is, by performing the control illustrated in FIG. 2, the job assignment device 10 may maintain the temperature of the liquid coolant, which is indicated by the temperature sensor TS1, so as to be fixed and cause the CPUs to be operated normally within the temperature range that is defined in the electrical specification.

As described above, according to the first embodiment illustrated in FIGS. 1 to 4, the job assignment device 10 suppresses charge of new jobs to the CPUs when the opening degree of the valve VLV is a certain threshold value VT1 or more. Thus, the temperature of the liquid coolant, which is indicated by the temperature sensor TS1, may be maintained so as to be fixed. As a result, the CPUs may be operated within the normal temperature range so that abort of the CPUs due to an abnormal increase in the temperature of the CPUs may be suppressed. That is, reduction of the reliability of the information processing device IPE may be suppressed.

When the opening degree of the valve VLV is 0% for a certain time period despite the situation that the CPUs are performing jobs, the job assignment device 10 detects that an abnormality occurs in the circulation device 20, issues an abnormality alarm, and charges an additional job. As a result, even when an abnormality occurs in which the valve VLV is fixed at a certain opening degree, dew condensation due to over-cooling of the CPUs may be suppressed, and dew condensation due to over-cooling of the supply route 30 may be suppressed. As a result, failures of the CPUs or the information processing device IPE may be suppressed, and reduction of the reliability of the information processing device IPE may be suppressed.

FIG. 6 illustrates an example in which a job assignment device in an information processing device according to a second embodiment controls job charging. The same symbol is assigned to an element that is the same as or similar to the element described in the first embodiment, and detailed description thereof is omitted herein. A configuration of the information processing device according to the second embodiment is similar to that of the information processing device IPE illustrated in FIG. 1, except that a program PGM that is executed by the processor PROC of the job assignment device 10 is different from that of the information processing device IPE illustrated in FIG. 1. In FIG. 6, the operations until the time t2 are similar to that in FIG. 2. In addition, the operation after a job is charged when the opening degree of the valve VLV is less than the threshold value VT1 is similar to that in FIG. 2.

According to the second embodiment, the job assignment device 10 compares the opening degree of the valve VLV with threshold values VT1 and VT2 to control the assignment of a job to the CPUs. For example, the threshold value VT1 is 80%, and the threshold value VT2 is 95%.

In the example illustrated in FIG. 6, due to the job charging at the time t4, the opening degree of the valve VLV exceeds the threshold values VT1 and VT2 and reaches 100% (“a” in FIG. 6), and the temperature of the liquid coolant, which is indicated by the temperature sensor TS1, starts to be increased (“b” in FIG. 6). In response to the situation that the opening degree of the valve VLV becomes the threshold value VT2 or more, the job assignment device 10 forcibly terminates at least one of the jobs that are being performed by the CPUs (“c” in FIG. 6). Due to the forced termination of the job, the amount of heat that is generated by the CPUs is reduced, and the temperature of the liquid coolant, which is indicated by the temperature sensor TS1, is gradually reduced (“d” in FIG. 6). However, the opening degree of the valve VLV is maintained at 100% until the temperature of the liquid coolant, which is indicated by the temperature sensor TS1, is returned to the temperature TP.

The job assignment device 10 waits for elapse of the time T1 after the forced termination of the job, and further forcibly terminates another job when the opening degree of the valve VLV is the threshold value VT2 or more after the time T1. In the example illustrated in FIG. 6, before the time T1 elapses, the temperature of the liquid coolant, which is indicated by the temperature sensor TS1, is returned to the value TP (“e” in FIG. 6), and the opening degree of the valve VLV is set at the threshold value VT1 or more and less than the threshold value VT2 (“f” in FIG. 6). Therefore, forced termination of another job is not performed.

At the time t6, at least one of the jobs that are being performed by the CPUs is completed (“g” in FIG. 6), the amount of heat that is generated by the CPUs is reduced, the temperature of the liquid coolant, which is measured by the temperature sensor TS2, is reduced, and the opening degree of the valve VLV becomes smaller than the threshold value VT1 (“h” in FIG. 6). At the time t7, in response to the situation the opening degree of the valve VLV becomes less than the threshold value VT1, the job assignment device 10 charges the forcibly-terminated job to the CPUs again (“i” in FIG. 6).

As illustrated in FIG. 6, when the opening degree of the valve VLV becomes the threshold value VT2 larger than the threshold value VT1 or more, the job assignment device 10 may suppress continued increase of the temperature of the liquid coolant, which is indicated by the temperature sensor TS1, by terminating a job that is being performed by the CPUs. Thus, increase of the temperature of the CPUs up to the maximum temperature that is defined in the electrical specification may be suppressed, and abnormal operations or failures of the CPUs may be suppressed. That is, reduction of the reliability of the information processing device IPE may be suppressed.

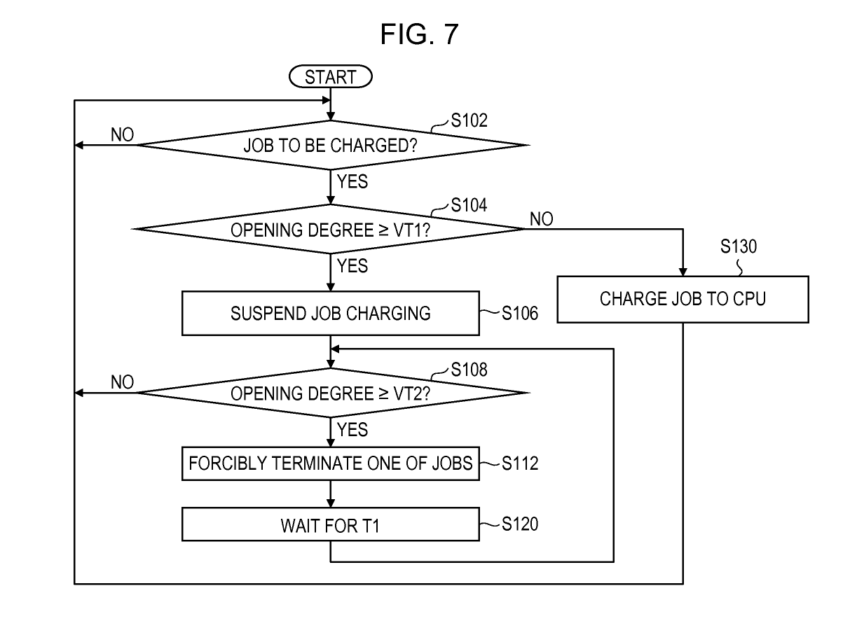

FIG. 7 illustrates an example of processing in which the job assignment device 10 according to the second embodiment controls job charging. Detailed description of processing that is the same as or similar to that in FIG. 3 is omitted herein. The job assignment device 10 performs the processing of the flow illustrated in FIG. 7 by executing a program. That is, FIG. 7 illustrates an example of a method for controlling the information processing device IPE.

S102, S104, S106, and S130 illustrated in FIG. 7 are the same or similar to S102, S104, S106, and S130 illustrated in FIG. 3. In the example illustrated in FIG. 7, S108 is performed after S106.

In S108, the job assignment device 10 determines whether or not the opening degree of the valve VLV is the threshold value VT2 or more. When the opening degree of the valve VLV is the threshold value VT2 or more, the processing proceeds to S112. When the opening degree of the valve VLV is less than the threshold value VT2, the processing returns to S102.

In S112, the job assignment device 10 forcibly terminates at least one of the jobs that are being performed by the CPUs. After that, in S120, the job assignment device 10 waits for elapse of the time T1, and then the processing returns to S108. As described above, the control illustrated in FIG. 6 is achieved by the flow illustrated in FIG. 7.

Similar to the first embodiment, the job assignment device 10 according to the second embodiment may suppress abort of the CPUs due to an abnormal temperature of the CPUs, by controlling job charging on the basis of the opening degree of the valve VLV. In addition, according to the second embodiment, when the opening degree of the valve VLV becomes the threshold value VT2 or more, the job assignment device 10 terminates a job that is being performed by the CPUs. As a result, increase of the temperature of the CPUs due to continued increase of the temperature of the liquid coolant may be suppressed, and abnormal operations or failures of the CPUs may be suppressed. That is, reduction of the reliability of the information processing device IPE may be suppressed.

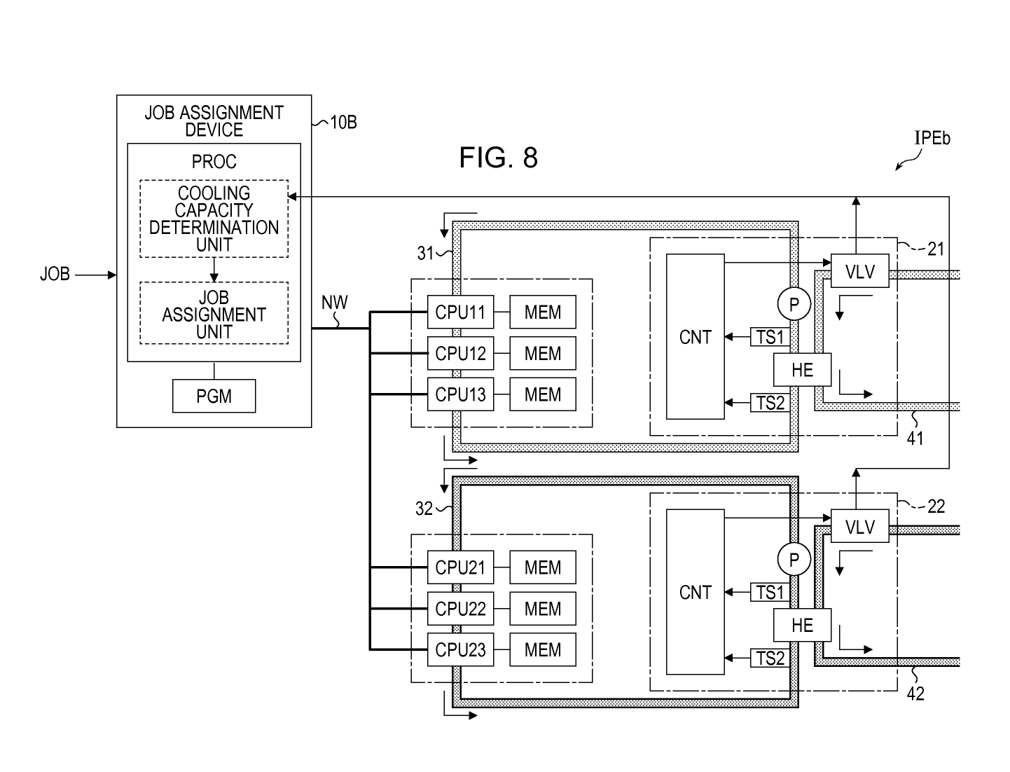

FIG. 8 illustrates an information processing device according to a third embodiment. The same symbol is assigned to an element that is the same as or similar to the element described in the first or second embodiments, and detailed description thereof is omitted herein. An information processing device IPEb illustrated in FIG. 8 includes a job assignment device 10B, instead of the job assignment device 10 illustrated in FIG. 1. The job assignment device 10B is similar to the job assignment device 10 illustrated in FIG. 1, except that a program PGM that is executed by the processor PROC is different from that of the job assignment device 10 illustrated in FIG. 1.

In addition, the information processing device IPEb includes a cooling system including a circulation device 21 and supply routes 31 and 41 that correspond to CPU11, CPU12, and CPU13, and a cooling system including a circulation device 22, and supply routes 32 and 42 that correspond to CPU21, CPU22, and CPU23. A configuration of each of the cooling systems is the same as or similar to the configuration of the cooling system that includes the circulation device 20 and the supply routes 30 and 40 illustrated in FIG. 1. The job assignment device 10B receives opening degree information that indicates the opening degree, from each of the valves VLV that are respectively included in the circulation devices 21 and 22. The number of cooling systems that are provided in the information processing device IPEb is not limited to two.

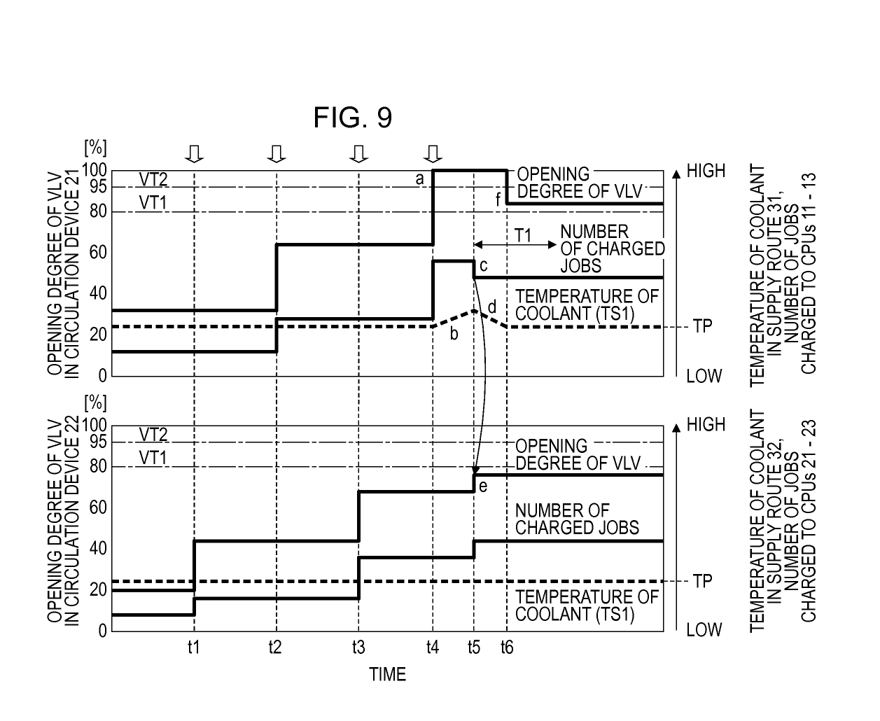

FIG. 9 illustrates an example in which the job assignment device 10B illustrated in FIG. 8 controls job charging. The operations when a job is charged in a case in which the opening degree of the valve VLV is less than the threshold value VT1 are similar to those in FIGS. 2 and 6. Detailed description of the operations that are similar to those in FIGS. 2 and 6 is omitted herein. In the example illustrated in FIG. 9, the job assignment device 10B receives an instruction of job charging, from the host device at each of the times t1, t2, t3, and t4. In response to the instruction received at the times t1 and t3, the job assignment device 10B charges a job to at least one of the CPU21, CPU22, and CPU23. In response to the instruction received at the times t2 and t4, the job assignment device 10B charges a job to at least one of the CPU11, CPU12, and CPU13.

Similar to FIG. 6, at the time t4, due to the job charging to at least one of the CPU11, CPU12, and CPU13, the opening degree of the valve VLV of the circulation device 21 exceeds the threshold values VT1 and VT2 and reaches 100% (“a” in FIG. 9). As a result, the temperature of the liquid coolant, which is indicated by the temperature sensor TS1, starts to be increased (“b” in FIG. 9). At the time t5, in response to the situation that the opening degree of the valve VLV of the circulation device 21 becomes the threshold value VT2 or more, the job assignment device 10B forcibly terminates at least one of the jobs that are being performed by the CPU11, CPU12, and CPU13 (“c” in FIG. 9). Due to the forced termination of the job, the amount of heat that is generated by the CPU11, CPU12, and CPU13 is reduced, and the temperature of the liquid coolant, which is indicated by the temperature sensor TS1 that is connected to the circulation device 21, is gradually reduced (“d” in FIG. 9).

The job assignment device 10B charges the terminated job to at least one of the CPU21, CPU22, and CPU23 that are connected to the circulation device 22 in which the opening degree of the valve VLV is less than the threshold value VT1 (“e” in FIG. 9). That is, the job assignment device 10B transfers the job, from the CPU that is connected to the circulation device 21 in which the opening degree of the valve VLV is the threshold value VT2 or more, to the CPU that is connected to the circulation device 22 in which the opening degree of the valve VLV is less than the threshold value VT1. As a result, in each of the cooling systems of the information processing device IPEb, the temperature of the liquid coolant, which is indicated by the temperature sensor TS1, is maintained so as to be fixed approximately, and the information processing device IPEb may be continued to operate normally.

The job assignment device 10 waits for elapse of the time T1 after the forced termination of the job, and further forcibly terminates another job when the opening degree of the valve VLV is the threshold value VT2 or more after the elapse of the time T1. In the example illustrated in FIG. 9, the temperature of the liquid coolant, which is indicated by the temperature sensor TS1, is returned to the value TP before the elapse of the time T1, and the opening degree of the valve VLV is set at the threshold value VT1 or more and less than the threshold value VT2 (“f” in FIG. 9). Therefore, forced termination of another job is not performed.

At the time t5, when there is no cooling system in which the opening degree of the valve VLV is less than the threshold value VT1, the job assignment device 10B may stack the terminated job, for example, without charging the terminated job to a CPU that is connected to another cooling system.

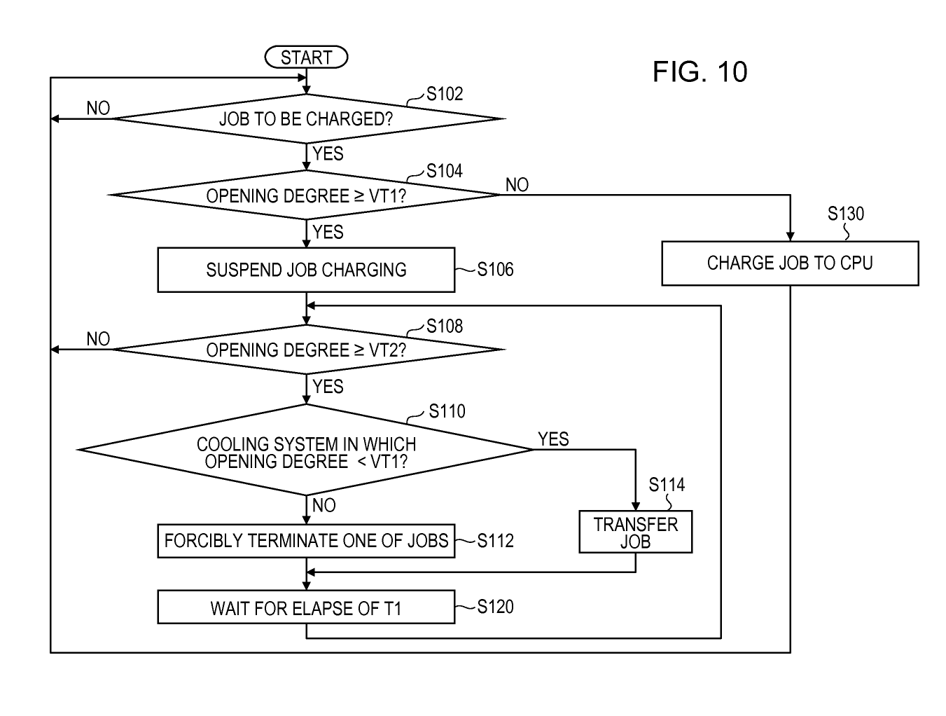

FIG. 10 illustrates an example of processing in which the job assignment device 10B according to the third embodiment controls job charging. Detailed description of processing that is the same as or similar to that in FIGS. 3 and 7 is omitted herein. The job assignment device 10B illustrated in FIG. 8 performs the processing of the flow illustrated in FIG. 10 by executing a program. That is, FIG. 10 illustrates an example of a method for controlling the information processing device IPEb.

S102, S104, S106, and S130 illustrated in FIG. 10 are the same as or similar to S102, S104, S106, and S130 illustrated in FIGS. 3 and 7. S108, S112, and S120 illustrated in FIG. 10 are the same as or similar to S108, S112, and S120 illustrated in FIG. 7. The job assignment device 10B performs the processing illustrated in FIG. 10, for each of the cooling systems.

In FIG. 10, when the opening degree of the valve VLV is the threshold value VT2 or more in S108, processing of S110 is performed. In S110, the job assignment device 10B determines whether or not the opening degree of the valve VLV is less than the threshold value VT1 in the other cooling system. When the opening degree of the valve VLV in the other cooling system is less than the threshold value VT1, the processing proceeds to S114. When the opening degree of the valve VLV is the threshold value VT1 or more in the other cooling system, the processing proceeds to S112.

In S114, the job assignment device 10B transfers at least one of the jobs that are performed by the CPUs that are included in the cooling system in which the opening degree of the valve VLV is the threshold value VT2 or more, to the other cooling system, and causes the CPUs that are included in the other cooling system to perform the transferred job. After that, the processing proceeds to S120, in which the job assignment device 10B waits for elapse of the time T1, and then the processing proceeds to S108. As described above, the control illustrated in FIG. 10 is achieved by the flow illustrated in FIG. 10.

Similar to the first embodiment, the job assignment device 10B according to the third embodiment may suppress abort of the CPUs due to an abnormal temperature of the CPUs, by controlling job charging on the basis of the opening degree of the valve VLV. In addition, according to the third embodiment, when the opening degree of any one of the valves VLV in the cooling systems becomes the threshold value VT2 or more, job assignment device 10B transfers a job that is being performed by the CPUs that are included in the cooling system in which the opening degree of the valve VLV is the threshold value VT2 or more to the CPUs that is connected to the cooling system in which the opening degree of the valve VLV is less than the threshold value VT1. As a result, even when the temperature of the liquid coolant is increased, a reduction in execution efficiency of a job is suppressed, and the information processing device IPEb may be kept to operate normally.

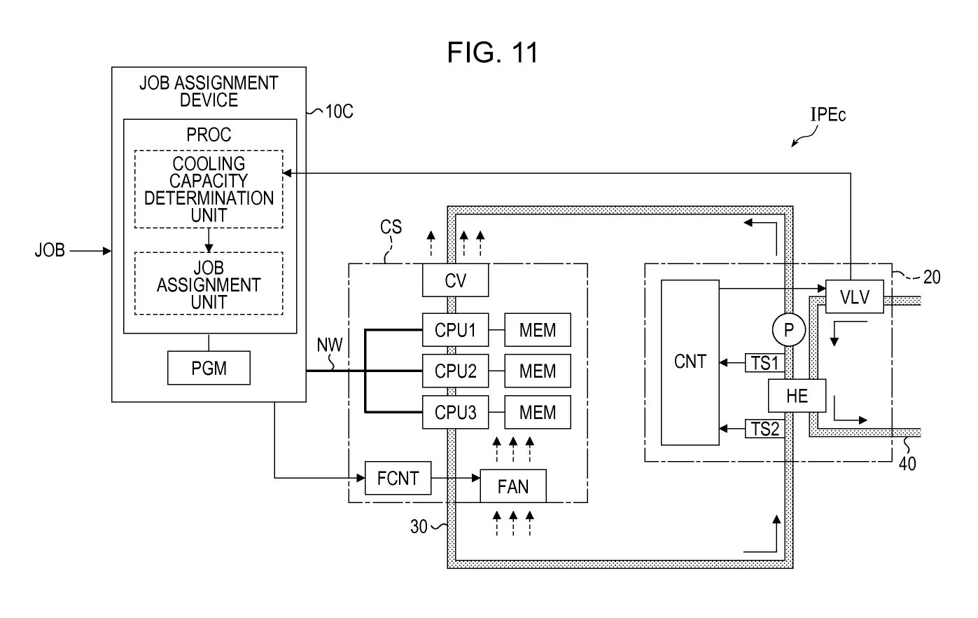

FIG. 11 illustrates an information processing device according to a fourth embodiment. The same symbol is assigned to an element that is the same as or similar to the element described in the first embodiment, and detailed description thereof is omitted herein. An information processing device IPEc illustrated in FIG. 11 includes a job assignment device 10C, instead of the job assignment device 10 illustrated in FIG. 1. The job assignment device 10C is similar to the job assignment device 10 illustrated in FIG. 1, except that a program PGM that is executed by the processor PROC is different from that of the job assignment device 10 illustrated in FIG. 1. For example, the CPU1, CPU2, and CPU3, and the memories MEM that are respectively connected to the CPU1, CPU2, and CPU3 are accommodated in a housing CS such as a rack.

In the housing CS, an air-cooling fan FAN, a fan control unit FCNT that controls the rotational speed of the air-cooling fan FAN, and a heat exchanger CV are installed. The heat exchanger CV is provided so as to face the air-cooling fan FAN across the CPU1, CPU2, and CPU3. The air-cooling fan FAN takes in, from the outside of the housing CS, air that is used to cool the CPU1, CPU2, and CPU3, and sends the taken-in air toward the CPU1, CPU2, and CPU3. The arrows of the broken lines illustrated in FIG. 11 indicate the flow of the air. The fan control unit FCNT adjusts the rotational speed of the air-cooling fan FAN to control the volume and the speed of the air that flows inside the housing CS, in accordance with an instruction received from the job assignment device 10C. The air-cooling fan FAN is an example of an air-blowing unit, and the heat exchanger CV is an example of a heat exchange unit.

For example, the heat exchanger CV includes a door having a liquid coolant passage through which liquid coolant flowing through the supply route 30 passes, cools air that is warmed by the CPU1, CPU2, and CPU3 by contacting with the air, and discharges the cooled air from the housing CS. That is, the heat exchanger CV performs heat exchange between the liquid coolant and the air that is sent from the air-cooling fan FAN and warmed by the CPU1, CPU2, and CPU3. For example, the heat exchanger CV is an exhaust air cooling door, which is a kind of a heat sink. An increase in the temperature of a room in which the information processing device IPEc is installed is suppressed due to the heat exchanger CV, as compared with a case in which the heat exchanger CV is not provided.

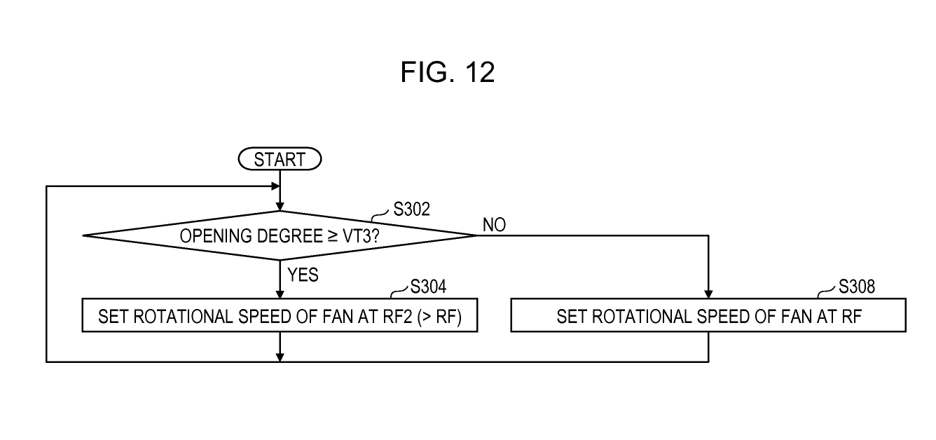

In addition to the function of the job assignment device 10 illustrated in FIG. 1, the job assignment device 10C has a function to control the fan control unit FCNT to adjust the rotational speed of the air-cooling fan FAN, on the basis of the opening degree information that indicates the opening degree of the valve VLV. The job assignment device 10C controls the volume and the speed of the air that flows inside the housing CS by adjusting the rotational speed of the air-cooling fan FAN. An example of the control of the rotational speed of the air-cooling fan FAN performed by the job assignment device 10C is illustrated in FIG. 12.

The job assignment device 10C illustrated in FIG. 11 may be installed in the information processing device IPEb, instead of the job assignment device 10B illustrated in FIG. 8. In this case, the information processing device IPEb illustrated in FIG. 8 includes the housing CS, the air-cooling fan FAN, the fan control unit FCNT, and the heat exchanger CV illustrated in FIG. 11, for each of the cooling systems.

FIG. 12 illustrates an example of processing in which the job assignment device 10C according to the fourth embodiment controls job charging. The job assignment device 10C illustrated in FIG. 11 performs the processing of the flow illustrated in FIG. 12 by executing a program. That is, FIG. 12 illustrates an example of a method for controlling the information processing device IPEc.

The job assignment device 10C performs the processing of the flow illustrated in FIG. 12 in parallel with the processing of the flow illustrated in FIG. 3. The job assignment device 10C may perform the processing of the flow illustrated in FIG. 12 alone, without performing the processing of the flow illustrated in FIG. 3. In addition, the processing of the flow illustrated in FIG. 12 may be performed by the job assignment device according to the second embodiment, or performed by the job assignment device 10B according to the third embodiment.

First, in S302, the job assignment device 10C determines whether or not the opening degree of the valve VLV is a threshold value VT3 or more. For example, the threshold value VT3 is a value that is larger than the threshold value VT1 illustrated in FIG. 6, and smaller than the threshold value VT2. When the opening degree of the valve VLV is the threshold value VT3 or more, the processing proceeds to S304. When the opening degree of the valve VLV is less than the threshold value VT3, the processing proceeds to S308.

In S304, the job assignment device 10C controls the fan control unit FCNT to set the rotational speed of the air-cooling fan FAN at RF2 that is larger than a regular rotational speed RF. That is, when the opening degree of the valve VLV is the threshold value VT3 or more, which is larger than the threshold value VT1, the job assignment device 10C increases the volume of the air that flows inside the housing CS, and increases an amount of heat exchanged between the air and the CPU1, CPU2, and CPU3 as compared with the case of the rotational speed RF. As a result, the amount of heat exchanged between the liquid coolant and the CPU1, CPU2, and CPU3 may be reduced relatively, and further increase of the opening degree of the valve VLV may be suppressed.

On the other hand, in S308, when the opening degree of the valve VLV is less than the threshold value VT3, the job assignment device 10C sets the rotational speed of the air-cooling fan FAN at the regular rotational speed RF. After S304 or S308, the processing returns to S302.

As described above, similar to the first embodiment, the job assignment device 10C according to the fourth embodiment may suppress abort of the CPUs due to an abnormal temperature of the CPUs, by controlling job charging on the basis of the opening degree of the valve VLV. In addition, according to the fourth embodiment, when the opening degree of the valve VLV is the threshold value VT3 or more, the job assignment device 10C increases the amount of heat exchanged between the air that is sent from the air-cooling fan FAN and the CPU1, CPU2, and CPU3. As a result, the amount of heat exchanged between the liquid coolant and the CPU1, CPU2, and CPU3 may be reduced relatively, and further increase of the opening degree of the valve VLV may be suppressed.

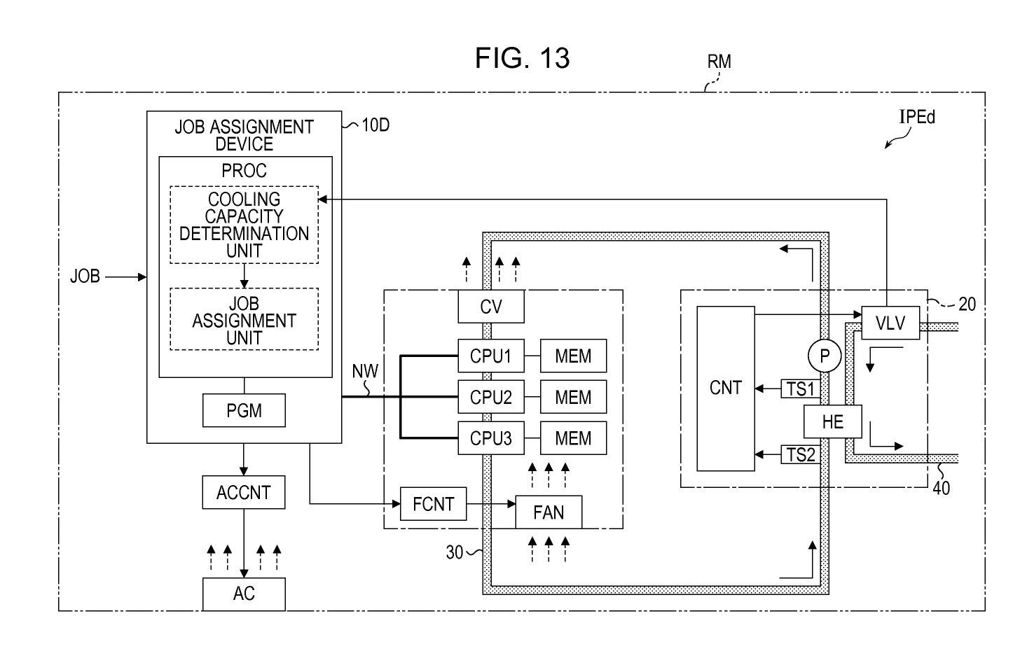

FIG. 13 illustrates an information processing device according to a fifth embodiment. The same symbol is assigned to an element that is the same as or similar to the element described in the first and fourth embodiments, and detailed description thereof is omitted herein.

An information processing device IPEd illustrated in FIG. 13 is installed in a room RM such as a server room. The information processing device IPEd includes a job assignment device 10D, instead of the job assignment device 10 illustrated in FIG. 1. The job assignment device 10D is similar to the job assignment device 10C illustrated in FIG. 11, except that a program PGM that is executed by the processor PROC is different from that of the job assignment device 10C illustrated in FIG. 11.

In the room RM in which the information processing device IPEd is installed, an air conditioning device AC that adjusts the temperature of the room RM and an air conditioning control device ACCNT are installed. In addition to the function of the job assignment device 10C illustrated in FIG. 11, the job assignment device 10D has a function of outputting, to the air conditioning control device ACCNT, an instruction for changing the cooling capacity of the air conditioning device AC to cool the room RM, on the basis of the opening degree information that indicates the opening degree of the valve VLV.

The job assignment device 10D illustrated in FIG. 13 may be provided in the information processing device IPEb, instead of the job assignment device 10B illustrated in FIG. 8. In this case, the information processing device IPEb illustrated in FIG. 8 includes the housing CS, the air-cooling fan FAN, the fan control unit FCNT, and the heat exchanger CV illustrated in FIG. 11, for each of the cooling systems, and is installed in the room in which the air conditioning device AC and the air conditioning control device ACCNT are installed.

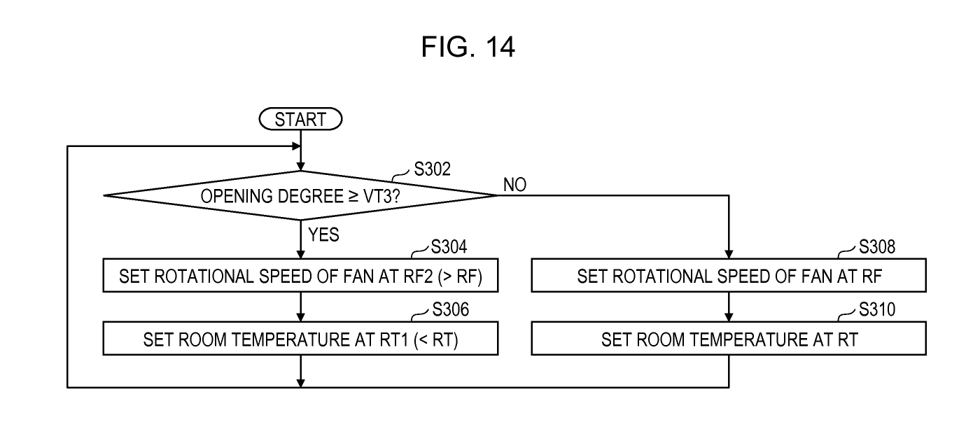

FIG. 14 illustrates an example of processing in which the job assignment device 10D illustrated in FIG. 13 controls job charging. Detailed description of processing that is the same as or similar to that in FIG. 12 is omitted herein. The job assignment device 10D illustrated in FIG. 13 performs the processing of the flow illustrated in FIG. 14 by executing a program. That is, FIG. 14 illustrates an example of a method for controlling the information processing device IPEd.

The job assignment device 10D performs the processing of the flow illustrated in FIG. 14 in parallel with the processing of the flow illustrated in FIG. 3. The job assignment device 10D may perform the processing of the flow illustrated in FIG. 14 alone, without performing the processing of the flow illustrated in FIG. 3. In addition, the processing of the flow illustrated in FIG. 14 may be performed by the job assignment device according to the second embodiment, or may be performed by the job assignment device 10B according to the third embodiment.

S302, S304, and S308 illustrated in FIG. 14 are the same as or similar to S302, S304, and S308 illustrated in FIG. 12. In FIG. 14, S306 is performed after S304, and S310 is performed after S308.

In S306, the job assignment device 10D outputs, to the air conditioning control device ACCNT, an instruction for causing the air conditioning device AC to reduce the temperature of the room RM. For example, the job assignment device 10D sets the temperature of the room RM, which is adjusted by the air conditioning device AC, at a temperature RT1 that is lower than the regular temperature RT. That is, when the opening degree of the valve VLV becomes the threshold value VT3 or more, which is larger than the threshold value VT1, the job assignment device 10D performs processing of increasing the rotational speed of the air-cooling fan FAN, and also performs processing of reducing the temperature of the room RM. For example, the regular temperature RT is 25° C., and the temperature RT1 is 22° C.

As a result, the temperature of the room RM is reduced after the opening degree of the valve VLV becomes the threshold value VT3 but not yet reaches 100%. Due to an reduction in the temperature of the room RM, the temperature of the air that is sent to the CPU1, CPU2, and CPU3 through the air-cooling fan FAN is reduced, so that the efficiency of cooling the CPU1, CPU2, and CPU3 through the air is improved, and the temperature of the liquid coolant, which is indicated by the temperature sensor TS2, is reduced. Thus, the situation that the opening degree of the valve VLV reaches 100% may be suppressed, and increase of the temperature of the liquid coolant, which is indicated by the temperature sensor TS1, may be suppressed.

On the other hand, in S310, the job assignment device 10D outputs, to the air conditioning control device ACCNT, an instruction for causing the air conditioning device AC to set the temperature of the room RM at the regular temperature RT. That is, when the opening degree of the valve VLV is less than the threshold value VT3, the job assignment device 10D sets the rotational speed of the air-cooling fan FAN at the regular rotational speed RF, and keeps the temperature of the room RM at the regular temperature RT. After S306 or S310, the processing returns to S302.

As described above, similar to the first embodiment, the job assignment device 10D according to the fifth embodiment may suppress abort of the CPUs due to an abnormal temperature of the CPUs, by controlling job charging on the basis of the opening degree of the valve VLV. In addition, similar to the fourth embodiment, the amount of heat exchanged between the liquid coolant and the CPU1, CPU2, and CPU3 may be reduced relatively, and further increase of the opening degree of the valve VLV may be suppressed.

In addition, in the fifth embodiment, when the opening degree of the valve VLV is the threshold value VT3 or more, the job assignment device 10D performs processing of increasing the rotational speed of the air-cooling fan FAN, and also performs processing of reducing the temperature of the room RM. As a result, the efficiency of cooling the CPU1, CPU2, and CPU3 through the air may be improved, and increase of the temperature of the liquid coolant, which is indicated by the temperature sensor TS1, may be suppressed.

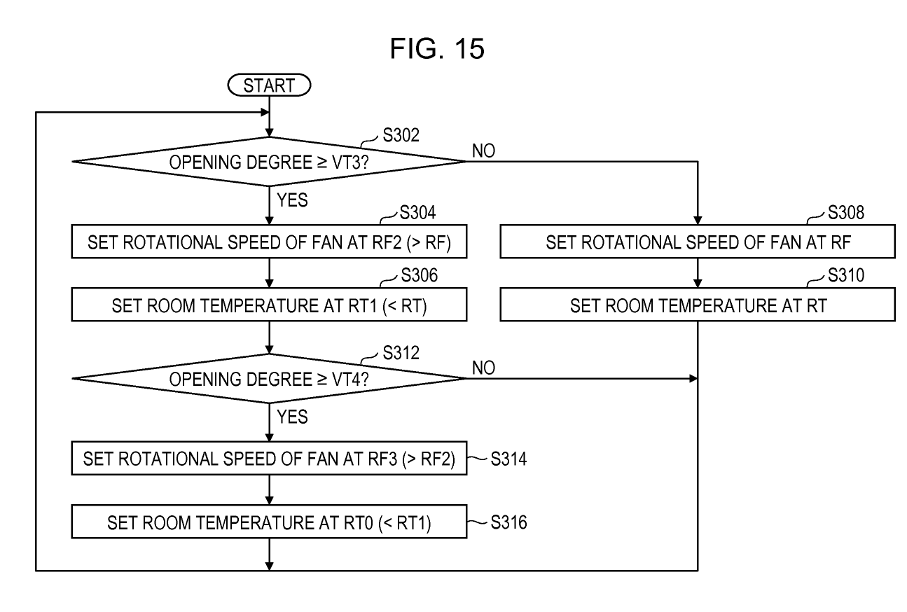

FIG. 15 illustrates an example of processing in which a job assignment device according to a sixth embodiment controls job charging. The same symbol is assigned to an element that is the same as or similar to the element described in the first and fourth embodiments, and detailed description thereof is omitted herein. A configuration of the information processing device according to the sixth embodiment is similar to the information processing device IPEd illustrated in FIG. 13, except that a program PGM that is executed by the processor PROC of the job assignment device 10D is different from that of the information processing device IPEd illustrated in FIG. 13. Similar to FIG. 13, the information processing device IPEd is installed in the room RM in which the temperature is adjusted by the air conditioning device AC. The job assignment device 10D illustrated in FIG. 13 performs the processing of the flow illustrated in FIG. 15 by executing a program. That is, FIG. 15 illustrates an example of a method for controlling the information processing device IPEd.

The job assignment device 10D performs the processing of the flow illustrated in FIG. 15 in parallel with the processing of the flow illustrated in FIG. 3. The job assignment device 10D may perform the processing of the flow illustrated in FIG. 15 alone, without performing the processing of the flow illustrated in FIG. 3. The processing of the flow illustrated in FIG. 15 may be performed by the job assignment device according to the second embodiment, or performed by the job assignment device 10B according to the third embodiment.

In FIG. 15, the job assignment device 10D performs processing that is similar to that in FIG. 14 when the opening degree of the valve VLV is the threshold value VT3 or more, and further performs S314 and S316 when the opening degree of the valve VLV is a threshold value VT4 or more, which is larger than the threshold value VT3. For example, the threshold value VT4 is the threshold value VT2 or less. S302, S304, S306, S308, and S310 illustrated in FIG. 15 are the same as or similar to S302, S304, S306, S308, and S310 illustrated in FIG. 14.

After S306, in S312, the job assignment device 10D determines whether or not the opening degree of the valve VLV is the threshold value VT4 or more. When the opening degree of the valve VLV is the threshold value VT4 or more, the processing proceeds to S314. When the opening degree of the valve VLV is less than the threshold value VT4, the processing returns to S302.

In S314, the job assignment device 10D controls the fan control unit FCNT to set the rotational speed of the air-cooling fan FAN at RF3 that is higher than RF2 so that the volume of the air that flows inside the housing CS further increases. In S316, the job assignment device 10D controls the air conditioning control device ACCNT to set the temperature of the room RM, which is adjusted by the air conditioning device AC, at a temperature RT0 that is lower than the temperature RT1. For example, the temperature RT0 is 20° C. As a result, the efficiency of cooling the CPU1, CPU2, and CPU3 through the air may be further improved as compared with that in FIG. 14, and increase of the temperature of the liquid coolant, which is indicated by the temperature sensor TS1, may be further suppressed as compared with that in FIG. 14.

The job assignment device 10D may omit S306, S310, and S316 to omit the control of the air conditioning device AC on the basis of the opening degree of the valve VLV.

As described above, similar to the first embodiment, the job assignment device 10D according to the sixth embodiment may suppress abort of the CPUs due to an abnormal temperature of the CPUs, by controlling job charging on the basis of the opening degree of the valve VLV. Similar to the fourth embodiment, the amount of heat exchange between the liquid coolant and the CPU1, CPU2, and CPU3 may be reduced relatively, and further increase of the opening degree of the valve VLV may be suppressed. In addition, as compared with the fifth embodiment, the efficiency of cooling the CPU1, CPU2, and CPU3 through the air may be further improved, and increase of the temperature of the liquid coolant, which is indicated by the temperature sensor TS1, may be suppressed.

A processing function of the job assignment device may be achieved by a computer. The program PGM may be recorded on a computer-readable recording medium. The computer-readable recording medium includes a magnetic storage device, an optical disk, a magneto-optical recording medium, a semiconductor memory, and the like. The magnetic storage device includes a hard disk device (HDD), a flexible disk (FD), a magnetic tape, and the like. The optical disk includes a digital versatile disk (DVD), a DVD random access memory (DVD-RAM), a compact disc read-only memory or rewritable (CD-ROM/RW), and the like. The magneto-optical recording medium includes a magneto-optical (MO) disk and the like.

For example, when distribution of the program PGM is performed, a portable recording medium such as a DVD and a CD-ROM to which the program PGM is recorded is marketed. In addition, the program PGM may be stored in a storage device of a server computer, and transferred from the server computer to another computer through a network.

For example, the computer that executes the program PGM stores the program PGM recorded on the portable recording medium or the program PGM transferred from the server computer, in a memory of the computer. The processor PROC of the computer reads the program PGM from the memory of the computer, and executes the program PGM to perform processing in accordance with the program PGM. The computer may read the program PGM from the portable recording medium directly, and perform the processing in accordance with the program PGM. In addition, the computer may also successively perform the processing in accordance with the received program PGM each time the program PGM is transferred from the server computer that is connected to the computer though the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device, comprising:
first arithmetic processing devices each configured to perform a job;
a first cooling device connected to the first arithmetic processing devices, the first cooling device including:
a first circulation unit configured to circulate first refrigerant through a first supply route, the first refrigerant absorbing heat generated by the first arithmetic processing devices,
a first cooling unit configured to cool the first refrigerant circulated by the first circulation unit, and
a first adjustment unit configured to adjust, in response to a first temperature of the first refrigerant, a first cooling capacity of the first cooling unit to cool the first refrigerant; and
a job assignment device including:
a processor configured to
control, on basis of cooling capacity information indicating the first cooling capacity, job charging to the first arithmetic processing devices.

2. The information processing device according to claim 1, wherein the processor is configured to
suspend job charging when the first cooling capacity is a first threshold value or more, and
resume job charging when the first cooling capacity becomes less than the first threshold value.

3. The information processing device according to claim 2, wherein the processor is configured to
terminate a first job when the first cooling capacity is a second threshold value or more, the first job being performed by the first arithmetic processing devices, the second threshold value being more than the first threshold value.

4. The information processing device according to claim 3, further comprising:
second arithmetic processing devices each configured to perform a job; and
a second cooling device connected to the second arithmetic processing devices, the second cooling device including:
a second circulation unit configured to circulate second refrigerant through a second supply route, the second refrigerant absorbing heat generated by the second arithmetic processing devices,
a second cooling unit configured to cool the second refrigerant circulated by the second circulation unit, and
a second adjustment unit configured to adjust, in response to a second temperature of the second refrigerant, a second cooling capacity of the second cooling unit to cool the second refrigerant,
wherein
the processor is configured to
charge, when the second cooling capacity is less than the first threshold value, the terminated first job to the second arithmetic processing devices.

5. The information processing device according to claim 1, further comprising:
an air-blowing unit configured to send air to the first arithmetic processing devices to cool the first arithmetic processing devices; and
a heat exchanger configured to exchange heat between the air sent from the air-blowing unit and the first refrigerant,
wherein
the processor is configured to
increase, when the first cooling capacity is a third threshold value or more, a volume of the air sent from the air-blowing unit.

6. The information processing device according to claim 5, wherein the processor is configured to
increase, when the first cooling capacity is the third threshold value or more, a second cooling capacity of an air conditioning device cooling a room in which the first arithmetic processing devices are installed.

7. The information processing device according to claim 5, wherein the processor is configured to
further increase, when the first cooling capacity is a fourth threshold value or more, the volume of the air sent from the air-blowing unit, the fourth threshold value being more than the third threshold value.

8. The information processing device according to claim 1, wherein the processor is configured to
detect, when the cooling capacity information is not changed after a first job is charged to the first arithmetic processing devices, occurrence of abnormality in the first cooling device and charge a second job to the first arithmetic processing devices.

9. The information processing device according to claim 1, wherein
the first cooling unit is configured to exchange heat between the first refrigerant and second refrigerant having a second temperature lower than the first temperature,
the first adjustment unit includes a valve for adjusting a flow rate of the first refrigerant, the valve being provided in the first supply route, and
the adjustment unit is configured to adjust the first cooling capacity by controlling an opening degree of the valve.

10. The information processing device according to claim 1, further comprising:
a first temperature sensor configured to measure the first temperature of the first refrigerant that flows through the first supply route into the cooling unit; and
a second temperature sensor configured to measure a second temperature of the first refrigerant that flows through the first supply route from the cooling unit,
wherein
the adjustment unit is configured to adjust, on basis of the first temperature and the second temperature, the first cooling capacity such that the second temperature is maintained to be a predetermined value.

11. A method for controlling an information processing device, the method comprising:
obtaining, by a computer, information indicating a cooling capacity of a cooling device to cool arithmetic processing devices performing a job; and
controlling, on basis of the obtained information, job charging to the arithmetic processing devices.

12. A computer-readable recording medium having stored therein a program for causing a computer to execute a process, the process comprising:
obtaining information indicating a cooling capacity of a cooling device to cool arithmetic processing devices performing a job; and
controlling, on basis of the obtained information, job charging to the arithmetic processing devices.
